(19) United States
(12) Patent Application Publication
(10) Pub. No.: US 2012/0098639 A1
(43) Pub. Date: Apr. 26, 2012

(54) METHOD AND APPARATUS FOR PROVIDING A DEVICE UNLOCK MECHANISM

(75) Inventor: Jari Ijas, Espoo (FI)

(73) Assignee: Nokia Corporation

(21) Appl. No.: 12/912,352

(22) Filed: Oct. 26, 2010

(51) Int. Cl. G06F 7/04

(52) U.S. Cl. 340/5.51

(57) ABSTRACT

A method for providing a device unlock mechanism for touch screen devices may include receiving an indication of a pinch event at a touch screen display generating a locked screen that prevents user interaction with hidden content obscured by the locked screen, generating a preview window providing visibility of a portion of the hidden content based on characteristics of the pinch event, and determining whether to unlock user interaction with the hidden content based on the characteristics of the pinch event. A corresponding apparatus and computer program product are also provided.

### TECHNOLOGICAL FIELD

Some example embodiments of the present invention relate generally to user interface technology and, more particularly, relate to a method and apparatus for providing a device unlocking mechanism.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, electronic book or reading device, etc.

In many situations, it may be desirable for the user to interface with a device such as a mobile terminal for the provision of an application or service. A user's experience during certain applications such as, for example, web browsing or navigating through content may be enhanced by using a touch screen display as the user interface. Furthermore, some users may have a preference for use of a touch screen display for entry of user interface commands over other alternatives. In recognition of the utility and popularity of touch screen displays, many devices, including some mobile terminals, now employ touch screen displays. As such, touch screen devices are now relatively well known in the art, with numerous different technologies being employed for sensing a particular point at which an object may contact the touch screen display.

### BRIEF SUMMARY

A method, apparatus and computer program product are provided to enable the use of a touch screen display for unlocking a device. In particular, a method, apparatus and computer program product are provided that may enable the user to utilize a pinch or pinch out event sensed at a touch screen display of a device for unlocking the device.

Some embodiments of the invention may provide a method, apparatus and computer program product for improving user experience relating to devices having touch screen interfaces. As a result, for example, mobile terminal users may enjoy improved capabilities with respect to locking and/or unlocking a device to enable or disable device operation for content navigation and other services or applications that may be used in connection with a touch screen display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a device unlock mechanism according to an example embodiment of the present invention;

FIG. 3 illustrates a view of a locked screen according to an example embodiment of the present invention;

FIG. 4, which includes FIGS. 4A, 4B, 4C and 4D, illustrates an example series of events that leads to an unlocking of the device according to an example embodiment of the present invention;

FIG. 5, which includes FIGS. 5A, 5B, 5C and 5D, illustrates a sequence of positions of objects and corresponding positions of shades through the course of an unlocking event according to an example embodiment of the present invention;

FIG. 6, which includes FIGS. 6A to 6H, illustrates an example series of operations and corresponding display features in which hidden content is revealed in the form of an expanding geometric shape responsive to a pinch event according to an example embodiment of the present invention;

FIG. 7, which includes FIGS. 7A, 7B and 7C, illustrates an example in which unlock instructions and a partially transparent region are displayed responsive to a touch event according to an example embodiment of the present invention; and

FIG. 8 is a block diagram according to an example method for providing a device unlock mechanism for touch screen devices according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of a device unlock mechanism for a touch screen display. Using some example embodiments, a user may be enabled to interact with a touch screen display using a pinch or pinch out gesture detected at the touch screen display as a signal to unlock the touch screen display. Accordingly, for example, the user interface of a touch screen display may initially be locked (e.g., presenting either a blank screen or a predetermined wallpaper or other display screen corresponding to a locked user interface). An example embodiment may then be utilized to provide a pinch or pinch out gesture on the touch screen display to provide the user with access to hidden content (e.g., a home screen or content associated with an application-specific display screen) being displayed but previously hidden due to the display of the blank screen other predetermined screen associated with the locked user interface over the top of the hidden content. Moreover, in some embodiments, the pinch or pinch out gesture may be utilized to obtain a preview of the hidden content prior to actually unlocking the user interface.

Accordingly, some example embodiments may not merely be used to provide access to content associated with one application that is overlaid by content associated with another application. Instead, some example embodiments may actually take the user interface of the device from a locked state, where any interaction with the device (other than an unlocking interaction) is not allowed, to an unlocked state, where interaction with the device is enabled.

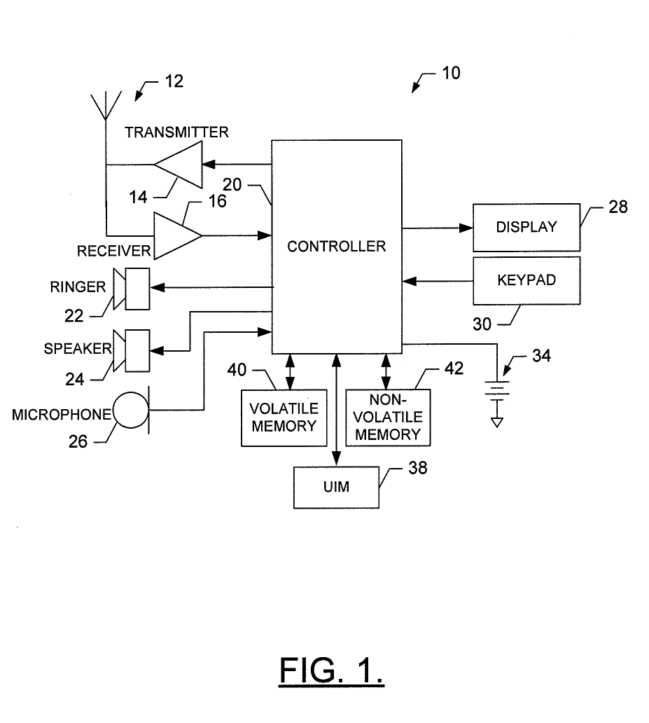

FIG. 1, one example embodiment of the invention, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

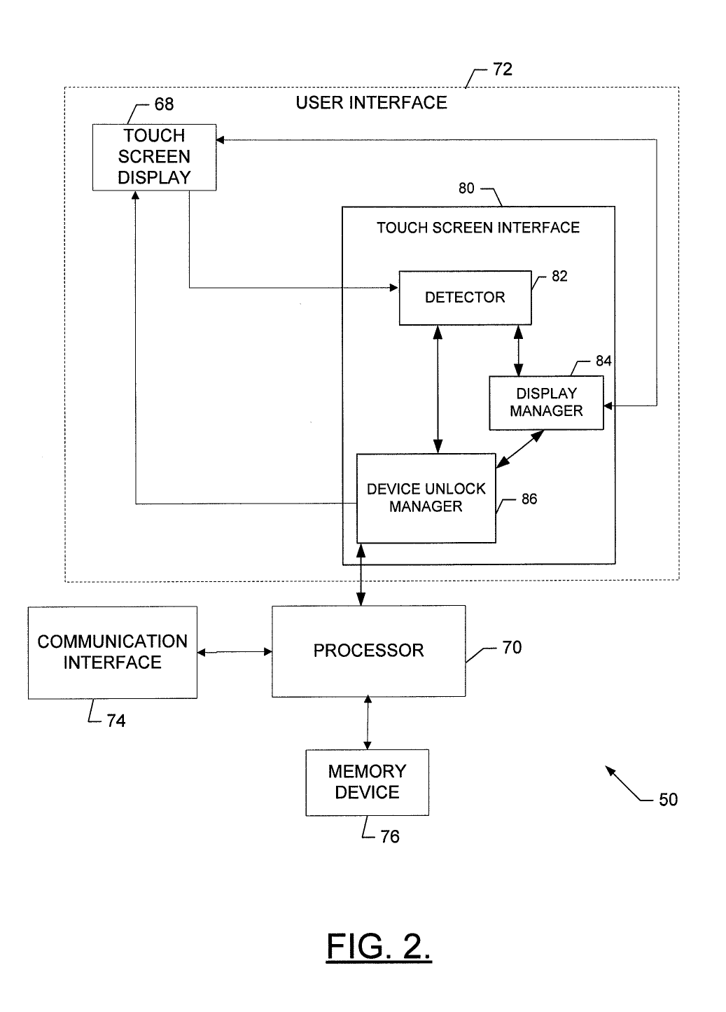

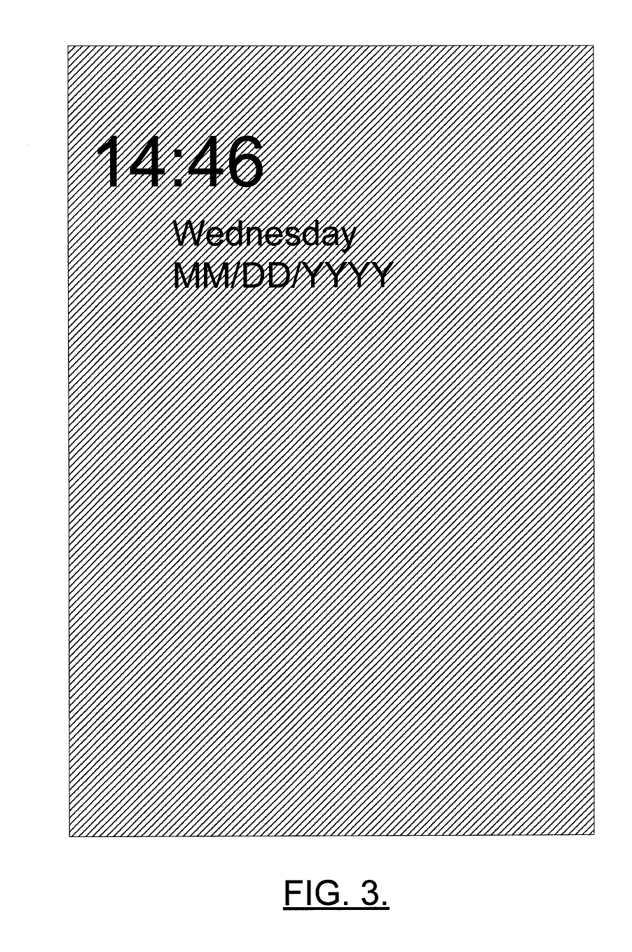

The mobile terminal 10 may include an antenna 12 (or multiple antennas) in operable communication with a transmitter 14 and a receiver 16. The mobile terminal 10 may further include an apparatus, such as a controller 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the invention will now be described with reference to FIG. 2, in which certain elements of an apparatus 50 for providing a device unlock mechanism for touch screen devices are displayed. The apparatus 50 of FIG. 2 may be employed, for example, in conjunction with the mobile terminal 10 of FIG. 1. However, it should be noted that the apparatus 50 of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of an apparatus for providing a device unlock mechanism for touch screen devices, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element. Moreover, although an example embodiment of the present invention described below will generally refer to unlocking access to a home screen of a device having an initially locked user interface, embodiments of the present invention more generally relate to unlocking access to any page, document, screen, content item, etc. over which a predefined screen associated with a locked user interface may be presented or displayed at a given time.

Referring now to FIG. 2, the apparatus 50 for providing a device unlocking mechanism for touch screen devices is provided and may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications.

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations.

In some embodiments, the touch screen interface 80 may include a detector 82, a display manager 84 and a device unlock manager 86. Each of the detector 82, the display manager 84 and the device unlock manager 86 may be any device or means embodied in either hardware or a combination of hardware and software configured to perform the corresponding functions associated with the detector 82, the display manager 84 and the device unlock manager 86, respectively, as described herein. In an exemplary embodiment, each of the detector 82, the display manager 84 and the device unlock manager 86 may be controlled by or otherwise embodied as the processor 70.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of the touch screen display 68 above a particular pressure threshold over a given area or the detection of a change in the electrostatic field of the touch screen display 68 at a particular location. As such, some touch events may not actually require physical contact with the touch screen display 68. Subsequent to each touch event, the detector 82 may be further configured to recognize and/or determine a corresponding classification of the event. In other words, the detector 82 may be configured to classify the touch event as any of a number of possible gestures. Some examples of recognizable gestures may include a touch, multi-touch, stroke, character, pinch event (e.g., a pinch in or pinch out) and/or the like.

A touch may be defined as a touch event that impacts a single area (without or with minimal movement on the surface of the touch screen display 68) and then is removed. A multi-touch may be defined as multiple touch events sensed at the same time (or nearly the same time). A stroke event may be defined as a touch event followed immediately by motion of the object initiating the touch event while the object remains in contact with the touch screen display 68. In other words, the stroke event may be defined by motion following a touch event thereby forming a continuous, moving touch event defining a moving series of instantaneous touch positions (e.g., as a drag operation or as a flick operation). Multiple strokes and/or touches may be used to define a particular shape or sequence of shapes to define a character. A pinch event may be classified as either a pinch out or a pinch in (hereinafter referred to simply as a pinch). A pinch may be defined as a multi-touch, where the touch events causing the multi-touch are spaced apart, followed by movement of the objects initiating the multi-touch substantially toward each other. Meanwhile, a pinch out may be defined as a multi-touch, where the touch events causing the multi-touch are relatively close together, followed by movement of the objects initiating the multi-touch substantially away from each other. In some cases, the objects on a pinch out may be so close together initially that they may be interpreted as a single touch, rather than a multi-touch, which then is modified by movement of two objects away from each other. In some examples, the objects associated with causing the multi-touch event may be spaced apart by any initial distance so long as the subsequent movement of the objects is in a direction apart from each other. In some cases, the detector 82 may be further enabled to determine characteristics regarding the touch events (e.g., length of time of a touch event, length of movement, direction of movement and/or speed of movement of the object). As such, the detector 82 may classify the touch events relative to various thresholds or ranges of lengths (in terms of time and distance), directions and/or speeds of movement.

In an example embodiment, the detector 82 may be configured to communicate detection information regarding the recognition, detection and/or classification of a touch event to the display manager 84 and/or the device unlock manager 86. The display manager 84 may be configured to provide control over modifications made to that which is displayed on the touch screen display 68 based on the detection information received from the detector 82. Meanwhile, the device unlock manager 86 may be configured to provide control over locking and/or unlocking the user interface 72 of the device with which the apparatus 50 is associated. Thus, for example, the user may lock the user interface of the device by providing a lock input (e.g., via the user interface 72) to direct the device unlock manager 86 to remove enablement for interaction with the device (or lock the device). The lock input may take the form of selection of a specific button, icon or menu option, or may be generated in response to a delay in user activity that lasts a predetermined length of time. While the device is locked, no or perhaps limited interaction with the device may be permitted via the user interface 72. In an example embodiment, the device unlock manager 86 may be configured to disable keys, audio interface options and/or touch display interface options while the device is locked. When locked, only certain interactions that are associated (or potentially associated) with unlocking the device may be processed either by the detector 82 or by other components of the touch screen interface 80.

In some embodiments, when the device is locked, the device unlock manager 86 may provide a signal or indication to the display manager 84 to indicate the locked condition so the display manager 84 may be informed to display a predetermined screen associated with the locked condition. FIG. 3 illustrates an example of a locked screen. The locked screen of FIG. 3 includes information regarding current time and date, but otherwise does not display any content or any data associated with any particular application that may otherwise be available via the device. Accordingly, the home screen (e.g., the screen from which various different applications for sharing, consuming, creating, modifying, or reviewing content or data may be launched) may not be visible or accessible while the display manager 84 presents the locked screen on the touch screen display 68 in the locked condition. As such, the locked screen may cover over or otherwise obscure the view of the home screen or any particular application or content associated with an application that may be opened from the home screen. Thus, for example, if the user locks the device (e.g., through action or inaction) while the device is displaying the home screen, the locked screen may cover over the home screen. However, if the user locks the device while the device was displaying content associated with a particular application, the content may be covered over by the locked screen when the device is in the locked state.

In an example embodiment, the display manager 84 may be configured to modify the locked screen displayed on the touch screen display 68 responsive to a pinch event (e.g., pinch or pinch out). In some cases, the pinch event may be detected by the detector 82 and be determined by the device unlock manager 86 as being sufficient to cause an unlocking of the device. However, regardless of whether the pinch event leads to an unlocking of the device, some embodiments may enable the display manager 84 to modify the locked screen based on the pinch event up until an unlocking occurs.

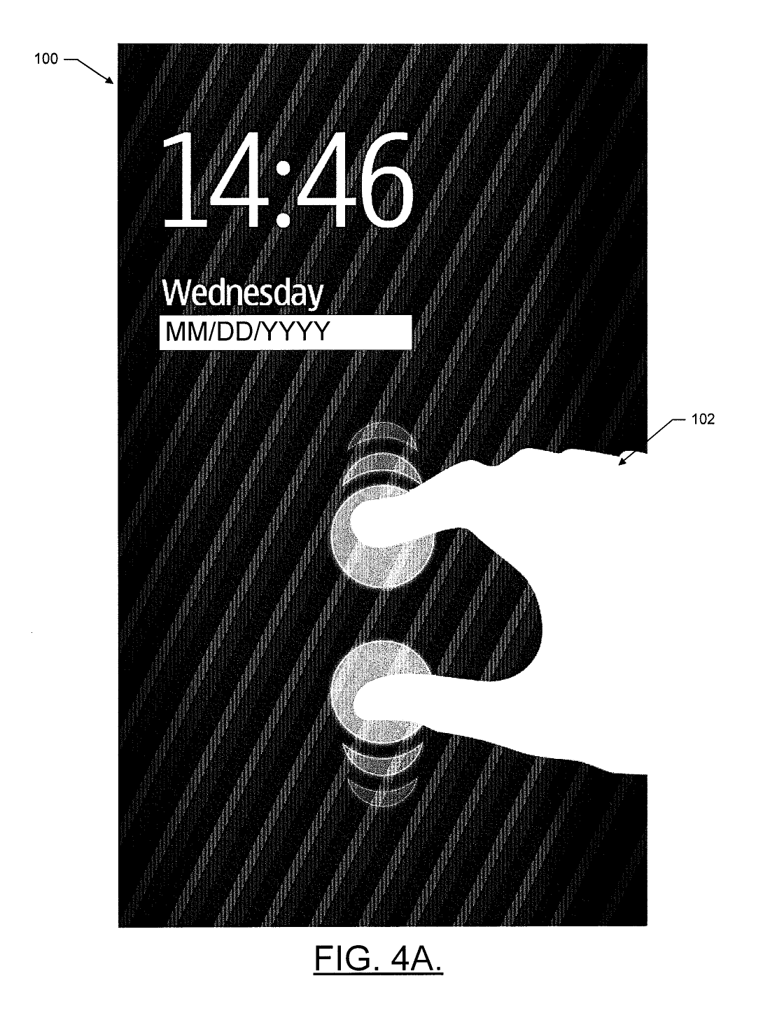

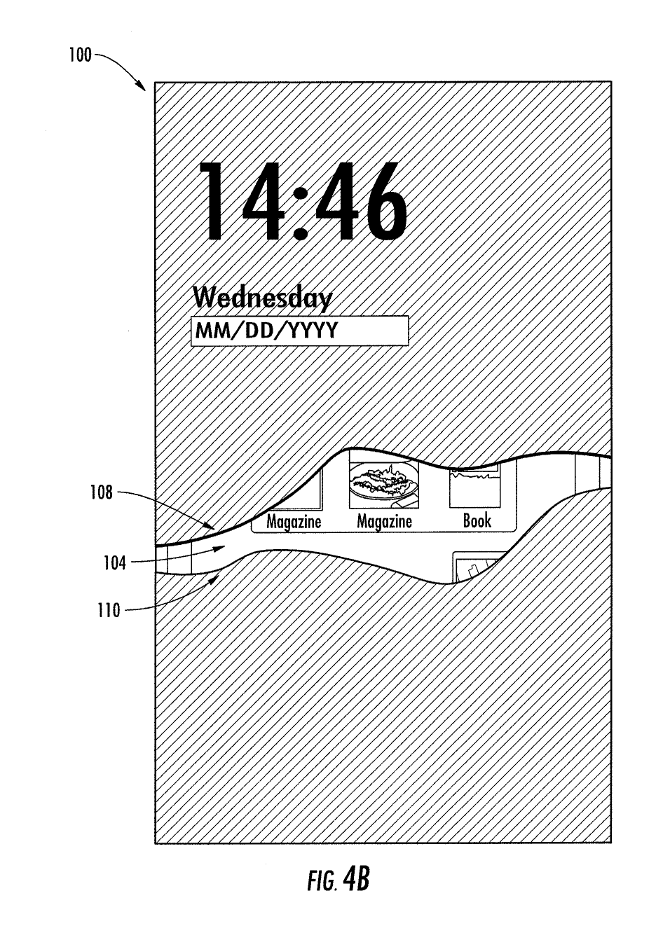

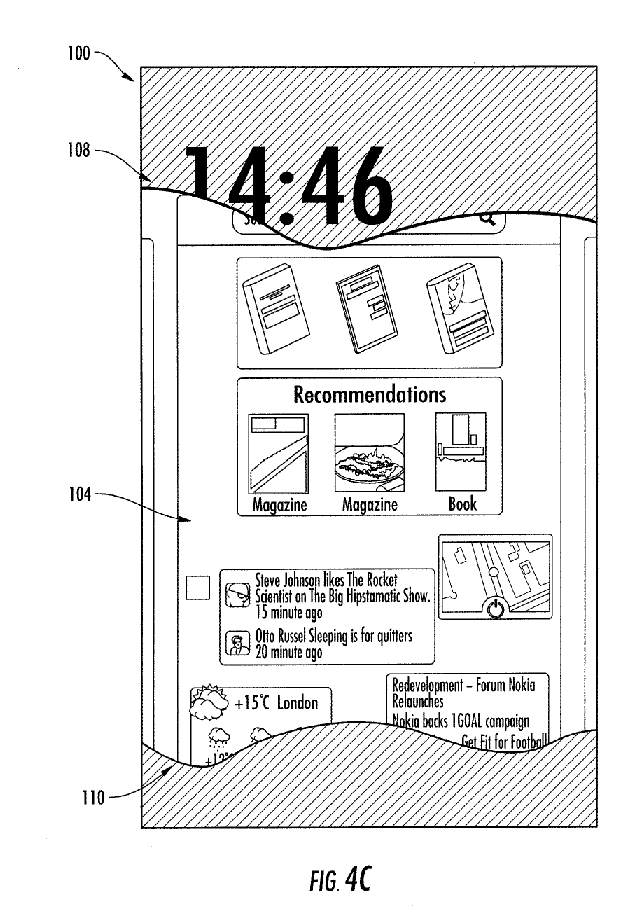

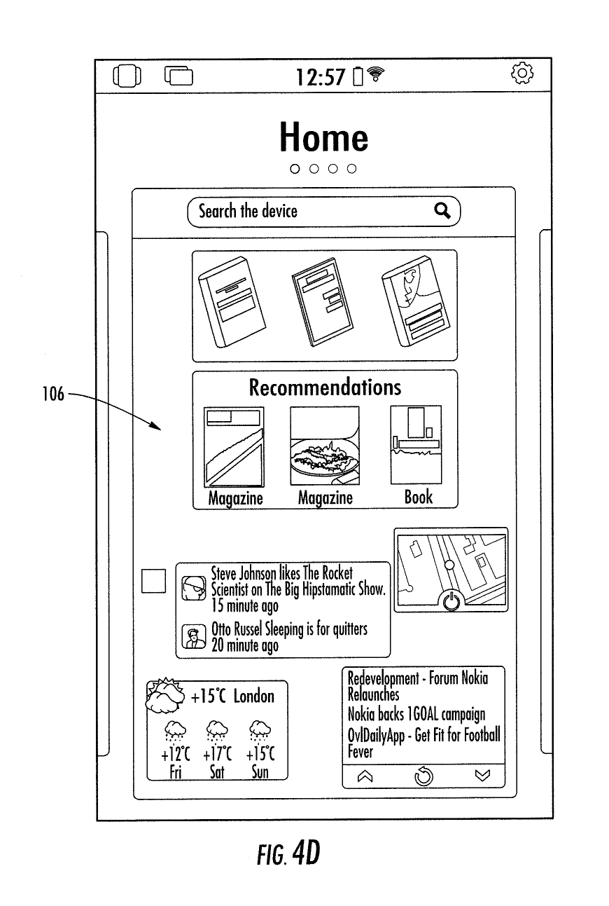

FIG. 4, which includes FIGS. 4A, 4B, 4C and 4D, illustrates an example that leads to an unlocking of the device. In this regard, FIG. 4A illustrates a locked screen 100 where a user's hand 102 causes a pinch event. As shown in FIG. 4A, the hand 102 causes a multi-touch and the fingers of the hand 102 are then moved away from each other while maintaining contact with the touch screen display 68. FIG. 4B removes the view of the hand 102 so the effects of the pinch out can be seen without interference. As shown in FIG. 4B, as the pinch out begins a portion of the locked screen 100 is split to reveal hidden content 104, which in this case is associated with a home screen. The split in the locked screen may grow proportional to or at least in relation to the movement of the objects (fingers) causing the pinch out. Thus, as the fingers begin to spread apart, a relatively small portion of the locked screen 100 may be replaced by the hidden content 104. As the fingers spread further apart, the portion of the locked screen 100 that is replaced by the hidden content 104 may grow in size (as shown in FIG. 4C). If the movement of the fingers is sufficient (e.g., responsive to a length (in time and/or distance) or speed of the pinch out exceeding a threshold value) to cause a determination to be made by the device unlock manager 86 to unlock the device, then the locked screen 100 may be completely removed and the application or content associated with the hidden content 104 may be fully revealed. Moreover, the user interface 72 may be unlocked so that interaction with the application or content associated with the hidden content 104 may be enabled. In the example of FIG. 4D, the home screen 106 is displayed when the locked screen 100 is removed responsive to unlocking of the display by the device unlock manager 86.

As shown in FIGS. 4B and 4C, the replacement of the portion of the locked screen 100 with the hidden content 104 may appear as though the locked screen 100 is split into two separate shades (108 and 110) that are retracted toward opposite edges of the display view. The shades 108 and 110 may have edges that are straight or curvilinear to some degree (as shown in FIGS. 4B and 4C). The position of the edges of the shades 108 and 110 may correlate directly or indirectly to the position of the fingers in different example embodiments. The hidden content 104 that is displayed between the shades 108 and 110 may form a preview window that essentially gives the user a preview of the content (e.g., associated with a specific application or the home screen) that is obscured by the locked screen 100. The shades 108 and 110 may have any shape. Moreover, the shape may change dynamically according to how far apart the shades 108 and 110 are from each other.

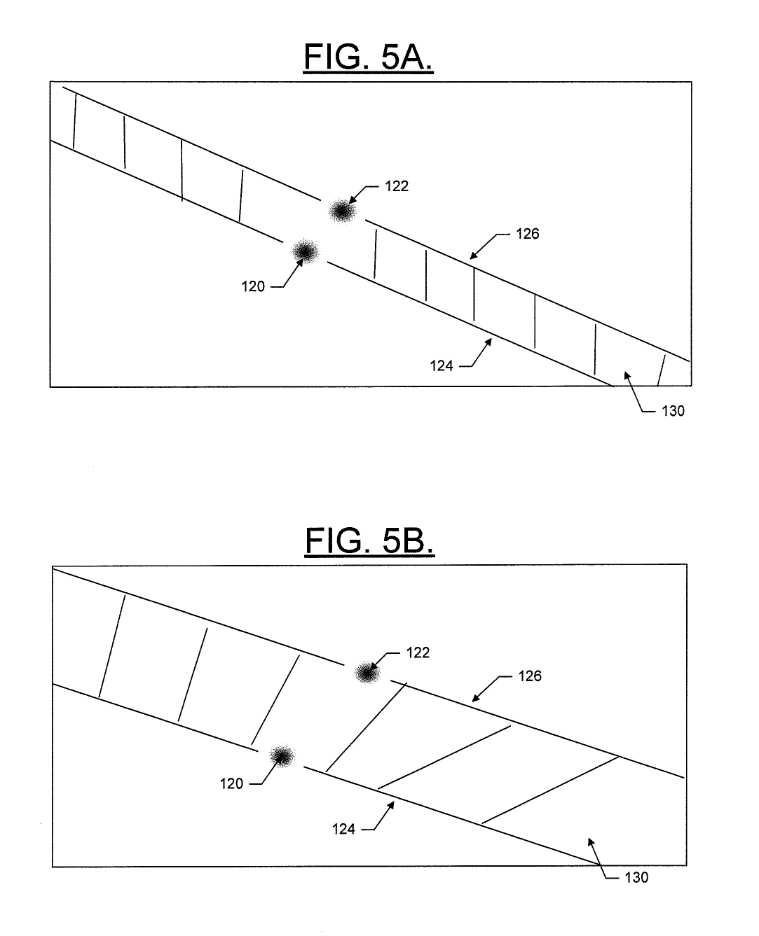

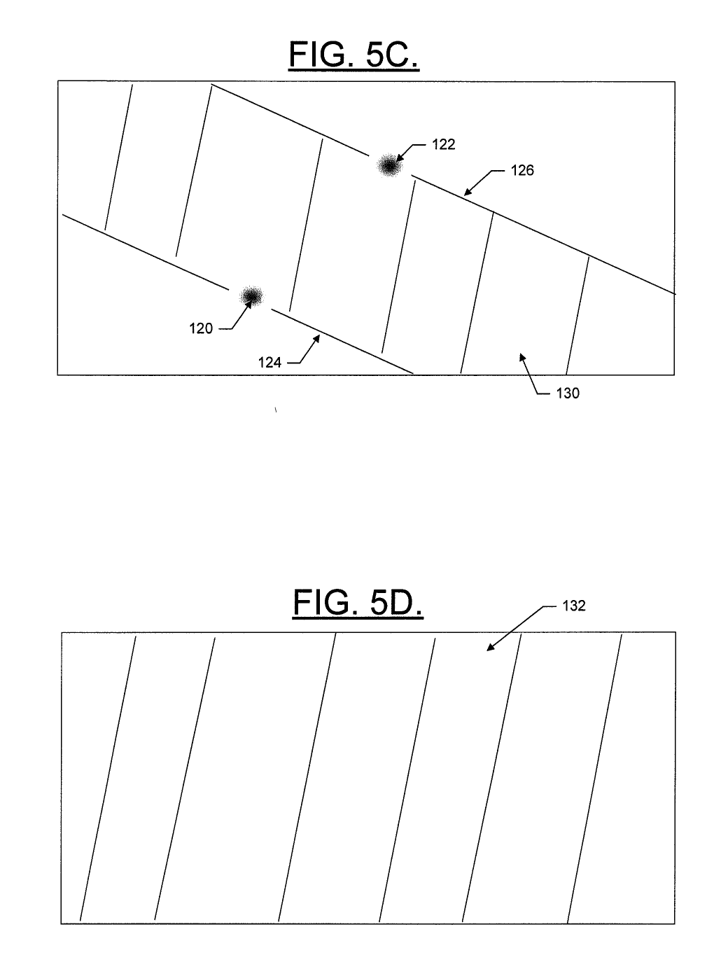

FIG. 5, which includes FIGS. 5A, 5B, 5C and 5D, illustrates an example in which straight edged shades are employed with the position of the edges of the shades corresponding directly to the position of the objects causing the touch event. FIG. 5 shows a sequence of positions of the objects and the corresponding positions of the shades through the course of an unlocking event. In this regard, for example, points associated with two touch points (points 120 and 122) are shown to separate away from each other responsive to a pinch out in the series of frames shown in FIGS. 5A to 5D. In FIG. 5A the touch points 120 and 122 are relatively close together and shade edges 124 and 126 are shown as straight lines that extend substantially perpendicular to the direction of movement of the touch points 120 and 122 as the objects causing the touch points 120 and 122 move. Extension of the shades 124 and 126 along a line substantially perpendicular to the direction of movement of the touch points 120 and 122 is not required and the angular difference between the direction of extension of the shades 124 and 126 and the direction of movement of the touch points 120 and 122 may be varied in some embodiments (either based on factory or user installed settings).

As the touch points 120 and 122 move away from each other in FIGS. 5B and 5C, the shades 124 and 126 may correspondingly separate from each other to reveal more hidden content 130. Finally, in FIG. 5C, if the distance between the touch points 120 and 122 reaches a predefined threshold, the device unlock manager 86 may signal as much to the display manager 84, and the display manager 84 may eliminate the shades 120 and 122 entirely to fully display the home screen or other hidden content that was previously covered by the locked screen that was split to form the shades 120 and 122. In this regard, FIG. 5D illustrates the home screen 132 displayed without any portion of the locked screen obscuring the view thereof.

In FIGS. 4 and 5, the shades split apart to display hidden content that extends between opposite edges of the display view along a linear or curvilinear border. However, in some examples, the hidden content could be revealed by the expansion of a portion of hidden content being exposed without necessarily extending to edges of the display view. Moreover, FIGS. 4 and 5 show the increased display or further revelation of hidden content responsive to a pinch out. However, in some examples, the hidden content could be revealed responsive to a pinch instead of a pinch out.

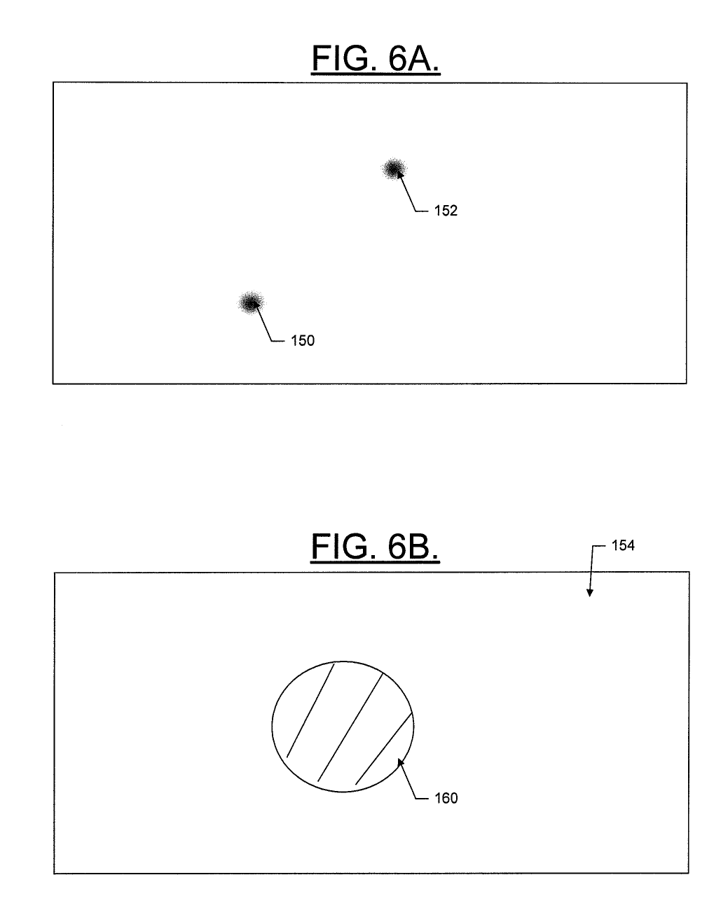

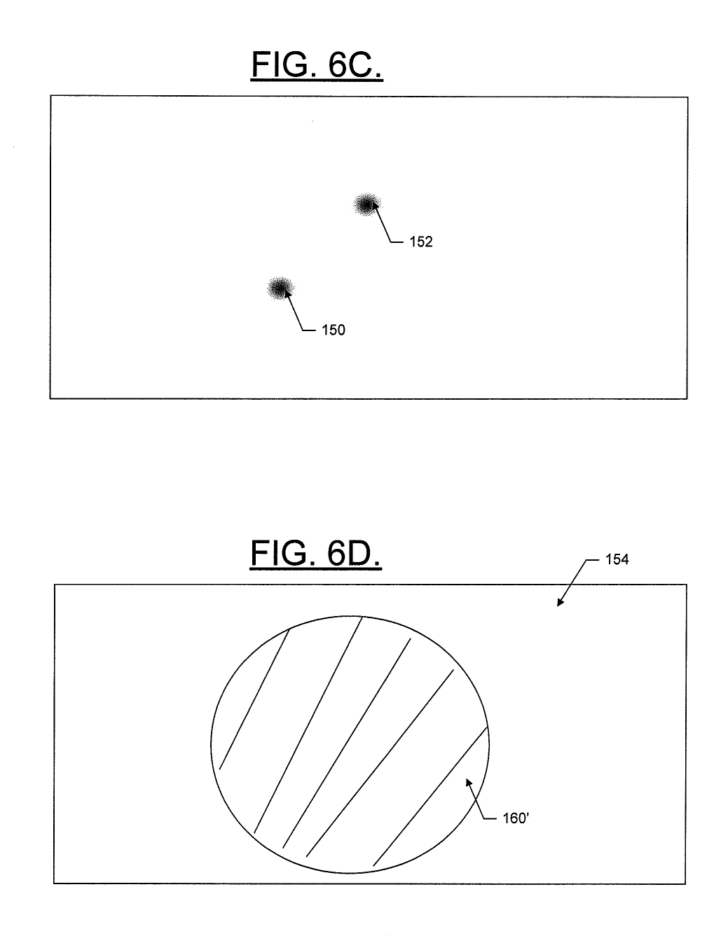

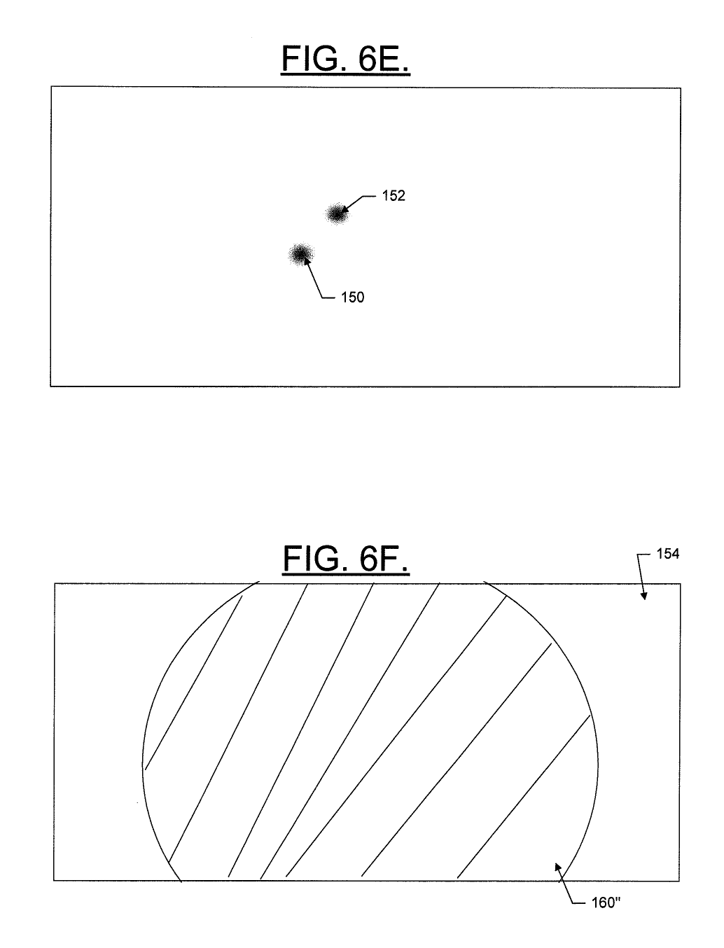

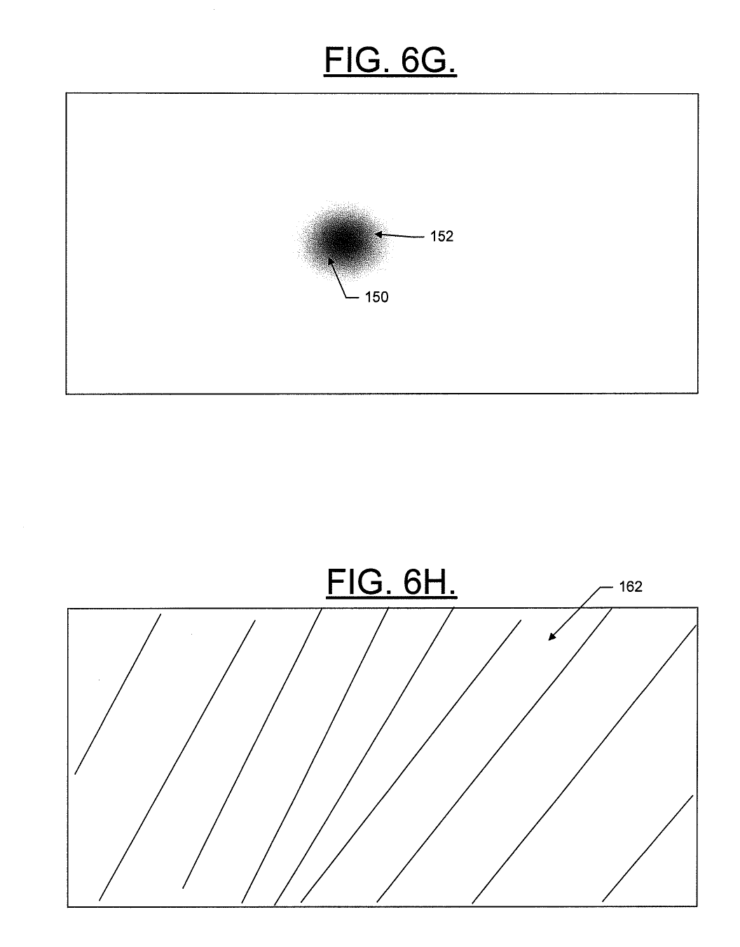

FIG. 6, which includes FIGS. 6A to 6H, illustrates an example in which hidden content is revealed in the form of an expanding geometric shape responsive to a pinch. In this regard, FIG. 6A shows initial touch points 150 and 152 on a display of a locked device (displaying a locked screen 154). Responsive to movement of these touch points 150 and 152 toward each other (as detected by the detector 82 and communicated to the display manager 84), the display manager 84 may begin to generate a preview window 160 displaying hidden content that is obscured by the locked screen 154. In FIGS. 6C and 6E, the touch points 150 and 152 may progressively move closer to each other to reveal respectively enlarged preview windows 160′ and 160″ as shown in FIGS. 6D and 6F, respectively. In FIG. 6G, the touch points 150 and 152 may substantially reach each other to unlock the display of the locked device and eliminate the locked screen 154 entirely and reveal the previously hidden content, which in this example is a home screen 162.

Although the preview windows shown in FIG. 6 have the general shape of a circle, any shape could be substituted for the circular shape that is shown in this example. Thus, the preview window 160 could have the shape of any geometric object or even an irregularly shaped object of the user's choosing. Additionally, although FIGS. 4-6 show a clearly defined boundary between the preview window and the locked screen, not all embodiments may employ such a clearly defined boundary. For example, in some embodiments, rather than creating a preview window that grows in size and is otherwise clearly visible when displayed, the preview window could be presented as fading in such that the preview window is initially relatively unclear or clouded, but clears up as the pinch event progresses. As such, certain characteristics of the preview window such as, for example, the shape and manner of implementation of the preview window, may be controllable by the user by employing corresponding settings or preferences.

The description above generally assumes that the touch screen display 68 is initially presenting a display of a locked screen that has limited information displayed thereon and is associated with a locked user interface. Thus, the user cannot interface with the home screen or any content or application that was opened prior to the locked screen being displayed. Moreover, the locked screen is unresponsive to inputs other than potential unlock inputs. In some embodiments, the user may desire for the touch screen display 68 to go into a sleep or rest mode to conserve battery power by turning off the display when there has been a sufficiently long period of inactivity or by direct invocation of such a mode. If the user initiates a sleep or rest mode, a specific button push or other indication may wake the device such that the touch screen display 68 is turned on and the locked screen is presented. The user may then unlock the locked screen to enable further interaction with the home screen or other applications as described above. In some examples, an initial touch of the touch screen display 68 may not only wake the display to present the locked screen, but may also present instructions to the user regarding unlocking and/or a partially transparent region around the location of the initial touch. These instructions and/or the partially transparent region may be presented in the absence of any prior wake event in some examples as well.

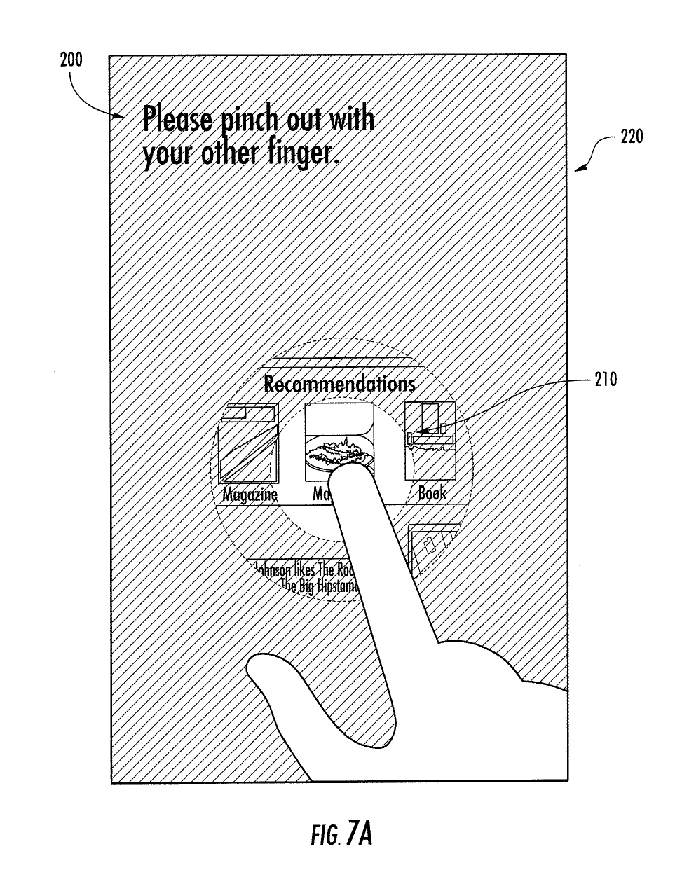

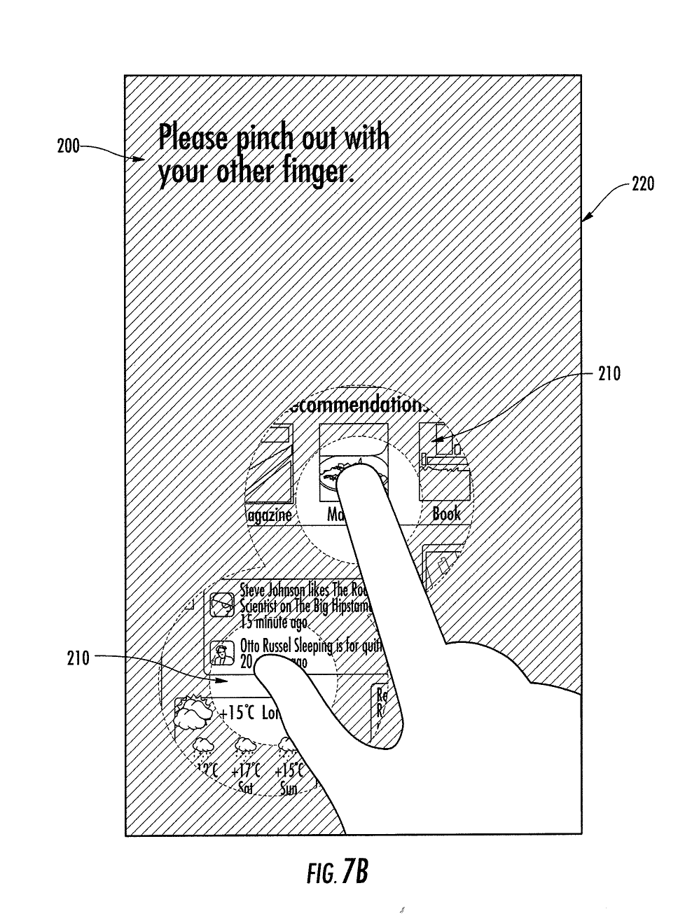

FIG. 7, which includes FIGS. 7A, 7B and 7C, illustrates an example in which unlock instructions 200 and a partially transparent region 210 are displayed responsive to a touch event according to an example embodiment. The initial state prior to the display of FIG. 7A may be the simple display of the locked screen (e.g., of FIG. 3). Responsive to detection of an initial touch event as shown in FIG. 7A, the unlock instructions 200 and the partially transparent region 210 may be displayed over the locked screen 220. The partially transparent region 210 may be a clouded view of the hidden content that is covered by the locked screen 220. As such, a portion of the locked screen 220 corresponding to the partially transparent region 210 may become at least partially transparent. In some embodiments, the partially transparent region 210 may fade out or become less transparent as the distance from the touch event causing the partially transparent region 210 increases and therefore also be more transparent or less clouded in appearance closer to the touch event. Thus, although an entirety of the partially transparent region 210 may be at least somewhat obscured, clouded or fogged in appearance, the portions of the partially transparent region 210 that are closest to the center of the partially transparent region 210 may be the clearest. In some cases, the partially transparent region 210 may not be displayed until an object touches the display screen. However, in some embodiments, the partially transparent region 210 may actually be displayed prior to the touch occurring to provide a hint to the user as to where to press in order to unlock the screen.

If the user causes another touch event with a second finger as shown in FIG. 7B, a second instance of the partially transparent region 210 may be presented corresponding to the second finger. Meanwhile, if the user begins a pinch event (as directed by the instructions 200), a preview window without obscurity (e.g., in the form of the expanding shades or shapes shown and described in relation to FIGS. 4-6) may be presented in similar fashion to the description provided above. In some embodiments, there may be an indication that is triggered when an unlock condition is encountered. The indication may, in some cases, be provided visually such as by the removal of the instructions 200, the removal of all portions of the locked screen, or a separate icon or indicator. The indication may also or alternatively be provided audibly, by tactile feedback or by any combination of visual, audible and tactile feedback. The indication may provide feedback to the user that may be useful in that it may let the user know that further efforts with regard to the pinch event are not needed to cause unlocking of the device. In situations where the pinch event is stopped prior to triggering the unlock condition, the preview window generated responsive to the pinch event may disappear immediately or fade over a predetermined decay time. A pinch event (e.g., even one that triggers an unlock condition) may be canceled by pinching in the opposite direction of the unlocking pinch.

In some embodiments, the instructions 200 may be provided in text that may describe the user activity that could be employed to unlock the device. However, the instructions 200 need not only be provided in text. For example, in FIG. 7C the instructions are provided as non-text visual instructions in the form of movement arrows 250. The movement arrows 250, in this example, form a border of a preview window 260. However, movement arrows could alternatively be displayed apart from the preview window 260 (e.g., in a direction box or instruction window). Moreover, in some embodiments a combination of text and non-text visual instructions may be provided.

In an example embodiment (as is shown in FIGS. 7A to 7C), any preview window or partially transparent region that is provided may enable the user to view content that is located in the region of the touch events that correspond to the pinch event. In other words, the preview window or partially transparent region may simply reveal content that would otherwise appear at the corresponding location on the display, if the device was unlocked. However, in some embodiments, specific content may be provided in the preview window regardless of the location of any touch event that causes the preview window to be displayed. For example, a clock or other fixed object or information source may be presented in response to any detected pinch event. In yet another alternative embodiment, different areas on the screen may provide views of different functions. For example, one portion of the display (e.g., the upper half) may show notifications, while another portion of the display (e.g., the bottom half) may show clock information in response to a pinch event. The behavior of the touch screen interface 80 responsive to a pinch event with respect to the presentation of instructions and previews of content at pinch locations, may be user definable based on settings or preferences.

In some embodiments, rather than unlocking the device, a pinch event may be used to enter or access a partially unlocked state. Thus, as opposed to an unlocked state, where normal functionality of the device user interface is provided with full access to interface functionalities, the partially unlocked state may enable access to only limited information and/or functionalities. In some cases, the access provided to various applications, information or user interface functionalities in the partially unlocked state may be configurable using user defined settings or preferences. After a predetermined time period (e.g., with or without further activity), the device may revert back to the locked state. As an example, the user may utilize the partially unlocked state to check current time (e.g., displaying only a clock) or to access other information in a read only mode. Thus, for example, in some cases the user may have limited access to information, with little or no ability to modify the information dependent upon the particular application that is operating in connection with the partially unlocked mode. As an example, the user in a clock review scenario described above may not have any reason to modify the time anyway. However, if the application being viewed in the partially unlocked mode were instead a map application, the user may be enabled to pan or zoom in the partially unlocked mode, but not change a destination or engage in other activities that may be available in an unlocked mode.

In an example embodiment, rather than providing a preview window or partially transparent region, the level of transparency of the entire display may be controlled based on a pinch event. For example, when in the unlocked state, the display may be fully visible (e.g., the transparency of the locked screen is 100%) and when in the locked state absent any pinch event, the display may be fully obscured (e.g., the transparency of the locked screen is 0%). When a touch or pinch event is commenced, the level of transparency may increase over the entirety of the display (rather than just at the region corresponding to the touch or pinch event) in proportion to the completion of an unlocking pinch event.

Accordingly, some example embodiments of the present invention may provide ways to unlock a device presenting a locked screen using a pinch event (e.g., a pinch or pinch out gesture) detected at a touch screen display. The pinch event may provide for the display of a preview window displaying hidden content that is otherwise obscured by the locked screen where visibility of the preview window (in terms of size, shape and/or clarity) is determined based on the relative position of the objects (e.g., fingers) causing the pinch event. If the characteristics of the pinch event are sufficient to trigger an unlock condition, the hidden content may be fully revealed and the locked screen may be removed to give the user an ability to interact with the previously hidden content.

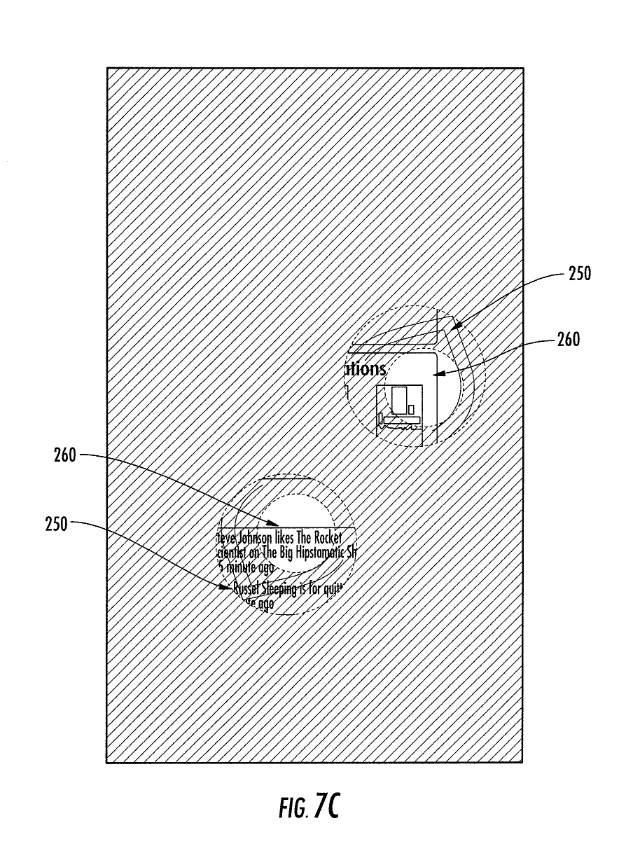

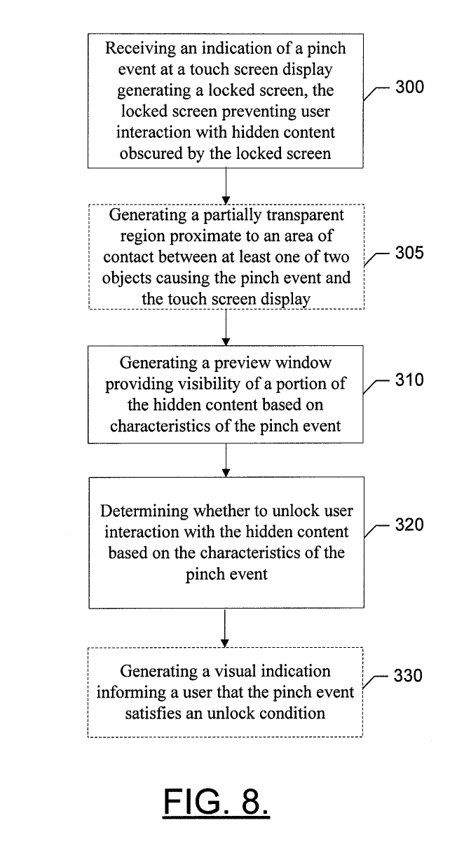

FIG. 8 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 8, may include receiving an indication of a pinch event at a touch screen display generating a locked screen at operation 300. The locked screen may prevent user interaction with hidden content obscured by the locked screen. The method may further include generating a preview window providing visibility of a portion of the hidden content based on characteristics of the pinch event at operation 310 and determining whether to unlock user interaction with the hidden content based on the characteristics of the pinch event at operation 320.

In some embodiments, certain ones of the operations above may be modified or further amplified as described below. Moreover, in some embodiments additional optional operations may also be included (some examples of which are shown in dashed lines in FIG. 8). It should be appreciated that each of the modifications, optional additions or amplifications below may be included with the operations above either alone or in combination with any others among the features described herein. In this regard, for example, the method may further include generating a partially transparent region proximate to an area of contact between at least one of two objects causing the pinch event and the touch screen display at operation 305. Alternatively or additionally, the method may include generating a visual indication informing a user that the pinch event satisfies an unlock condition at operation 330. In an example embodiment, receiving the indication of the pinch event may include receiving an indication of a pinch in which movement of two objects causing the pinch event move toward each other. In some embodiments, receiving the indication of the pinch event may include receiving an indication of a pinch out in which movement of two objects causing the pinch event move away from each other. In some example cases, generating the preview window may include generating a view of the portion of the hidden content that is sized based on a distance between two objects causing the pinch event. In an example embodiment, generating the preview window may include generating a split in the locked screen defined between shades that extend parallel to each other toward edges of the touch screen display in which the shades retract away from each other toward opposite edges of the touch screen display based on a distance between two objects causing the pinch event. In some embodiments, generating the preview window may further include generating edges of the shades to extend in a direction substantially perpendicular to a direction of movement of the two objects. In some cases, generating the preview window may include generating a geometric shape at a region corresponding to the pinch event such that a region inside the geometric shape provides a view of the hidden content. The geometric shape may have a size determined based on a distance between two objects causing the pinch event. In an example embodiment, determining whether to unlock user interaction may include comparing a distance between two objects causing the pinch event to a threshold and performing the determining based on a result of the comparing.

In an example embodiment, an apparatus for performing the method of FIG. 8 above may comprise a processor (e.g., the processor 70) configured to perform some or each of the operations (300-330) described above. The processor may, for example, be configured to perform the operations (300-330) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-330 may comprise, for example, the touch screen interface 80 (or respective different components thereof). Additionally or alternatively, at least by virtue of the fact that the processor 70 may be configured to control or even be embodied as the touch screen interface 80, the processor 70 and/or a device or circuitry for executing instructions or executing an algorithm for processing information as described above may also form example means for performing operations 300-330.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a pinch event at a touch screen display generating a locked screen, the locked screen preventing user interaction with hidden content obscured by the locked screen;
generating a preview window providing visibility of a portion of the hidden content based on characteristics of the pinch event; and
determining whether to unlock user interaction with the hidden content based on the characteristics of the pinch event.

2. The method of claim 1, wherein receiving the indication of the pinch event comprises receiving an indication of a pinch in which movement of two objects causing the pinch event move toward each other.

3. The method of claim 1, wherein receiving the indication of the pinch event comprises receiving an indication of a pinch out in which movement of two objects causing the pinch event move away from each other.

4. The method of claim 1, wherein generating the preview window comprises generating a view of the portion of the hidden content that is sized based on a distance between two objects causing the pinch event.

5. The method of claim 1, wherein generating the preview window comprises generating a split in the locked screen defined between shades that extend parallel to each other toward edges of the touch screen display, the shades retracting away from each other toward opposite edges of the touch screen display based on a distance between two objects causing the pinch event.

6. The method of claim 5, wherein generating the preview window further comprises generating edges of the shades to extend in a direction substantially perpendicular to a direction of movement of the two objects.

7. The method of claim 1, wherein generating the preview window comprises generating a geometric shape at a region corresponding to the pinch event, a region inside the geometric shape providing a view of the hidden content, the geometric shape having a size determined based on a distance between two objects causing the pinch event.

8. The method of claim 1, wherein determining whether to unlock user interaction comprises comparing a distance between two objects causing the pinch event to a threshold and performing the determining based on a result of the comparing.

9. The method of claim 1, further comprising generating a partially transparent region proximate to an area of contact between at least one of two objects causing the pinch event and the touch screen display.

10. The method of claim 1, further comprising generating a visual indication informing a user that the pinch event satisfies an unlock condition.

11. An apparatus comprising at least one processor and at least one memory including computer program code, the at least one memory and the computer program code configured to, with the processor, cause the apparatus to at least:
receive an indication of a pinch event at a touch screen display generating a locked screen, the locked screen preventing user interaction with hidden content obscured by the locked screen;
generate a preview window providing visibility of a portion of the hidden content based on characteristics of the pinch event; and
determine whether to unlock user interaction with the hidden content based on the characteristics of the pinch event.

12. The apparatus of claim 1, wherein the memory and computer program code are configured to, with the processor, cause the apparatus to receive the indication of the pinch event by receiving an indication of a pinch in which movement of two objects causing the pinch event move toward each other or receiving an indication of a pinch out in which movement of two objects causing the pinch event move away from each other.

13. The apparatus of claim 1, wherein the memory and computer program code are configured to, with the processor, cause the apparatus to generate the preview window by generating a view of the portion of the hidden content that is sized based on a distance between two objects causing the pinch event or by generating a split in the locked screen defined between shades that extend parallel to each other toward edges of the touch screen display, the shades retracting away from each other toward opposite edges of the touch screen display based on a distance between two objects causing the pinch event.

14. The apparatus of claim 1, wherein the memory and computer program code are configured to, with the processor, cause the apparatus to generate the preview window by generating a geometric shape at a region corresponding to the pinch event, a region inside the geometric shape providing a view of the hidden content, the geometric shape having a size determined based on a distance between two objects causing the pinch event.

15. The apparatus of claim 1, wherein the memory and computer program code are configured to, with the processor, cause the apparatus to determine whether to unlock user interaction by comparing a distance between two objects causing the pinch event to a threshold and performing the determining based on a result of the comparing.

16. The apparatus of claim 1, wherein the memory and computer program code are further configured to, with the processor, cause the apparatus to generate a partially transparent region proximate to an area of contact between at least one of two objects causing the pinch event and the touch screen display.

17. The apparatus of claim 1, wherein the memory and computer program code are further configured to, with the processor, cause the apparatus to generate a visual indication informing a user that the pinch event satisfies an unlock condition.

18. A computer program product comprising at least one non-transitory computer-readable storage medium having computer-executable program code instructions stored therein, the computer-executable program code instructions comprising program code instructions to:
receive an indication of a pinch event at a touch screen display generating a locked screen, the locked screen preventing user interaction with hidden content obscured by the locked screen;
generate a preview window providing visibility of a portion of the hidden content based on characteristics of the pinch event; and
determine whether to unlock user interaction with the hidden content based on the characteristics of the pinch event.

19. The computer program product of claim 18, wherein program code instructions for receiving the indication of the pinch event include instructions for receiving an indication of a pinch in which movement of two objects causing the pinch event move toward each other or receiving an indication of a pinch out in which movement of two objects causing the pinch event move away from each other.

20. The computer program product of claim 18, wherein program code instructions for generating the preview window include instructions for generating a view of the portion of the hidden content that is sized based on a distance between two objects causing the pinch event or for generating a split in the locked screen defined between shades that extend parallel to each other toward edges of the touch screen display, the shades retracting away from each other toward opposite edges of the touch screen display based on a distance between two objects causing the pinch event.

21. The computer program product of claim 18, wherein program code instructions for generating the preview window include instructions for generating a geometric shape at a region corresponding to the pinch event, a region inside the geometric shape providing a view of the hidden content, the geometric shape having a size determined based on a distance between two objects causing the pinch event.

22. The computer program product of claim 18, wherein program code instructions for determining whether to unlock user interaction include instructions for comparing a distance between two objects causing the pinch event to a threshold and performing the determining based on a result of the comparing.

23. The computer program product of claim 18, further comprising program code instructions for generating a partially transparent region proximate to an area of contact between at least one of two objects causing the pinch event and the touch screen display.

24. The computer program product of claim 18, further comprising program code instructions for generating a visual indication informing a user that the pinch event satisfies an unlock condition.
